(19) United States
(12) Patent Application Publication
(10) Pub. No.: US 2025/0155092 A1
(43) Pub. Date: May 15, 2025

(54) PHOSPHOR, WAVELENGTH CONVERSION DEVICE, ILLUMINATION DEVICE, AND PROJECTOR

(71) Applicant: Seiko Epson Corporation, Tokyo (JP)

(72) Inventor: Kengo KANO, Matsumoto-shi (JP)

(73) Assignee: Seiko Epson Corporation, Tokyo (JP)

(21) Appl. No.: 18/945,137

(22) Filed: Nov. 12, 2024

(30) Foreign Application Priority Data
Nov. 13, 2023 (JP) 2023-192958

(51) Int. Cl. F21K 9/64; G03B 21/20

(52) U.S. Cl. CPC F21K 9/64; G03B 21/204

(57) ABSTRACT

A phosphor includes a phosphor body including a phosphor phase made of A₃B₅O₁₂:Ce having a garnet structure, and a matrix phase having a refractive index higher than a refractive index of the phosphor phase. A content of the phosphor phase is 56 vol % or more and 70 vol % or less in a volume ratio with respect to the phosphor body. A ratio of Ce to A in terms of number of atoms is 0.004 or more and 0.04 or less. A thickness of the phosphor body is 45 μm or more and 150 μm or less. A is at least one selected from the group consisting of Lu, Gd, Tb, Ga, and Y, and B is Al.

The present application is based on, and claims priority from JP Application Serial Number 2023-192958, filed Nov. 13, 2023, the disclosure of which is hereby incorporated by reference herein in its entirety.

### BACKGROUND

### 1. Technical Field

The present disclosure relates to a phosphor, a wavelength conversion device, an illumination device, and a projector.

### 2. Related Art

In the related art, a ceramic composite is used as a wavelength conversion member used in a light source for a projector. JP-A-2012-062459 below discloses a ceramic composite formed of an inorganic material having a matrix phase made of a transparent ceramic such as Al₂O₃, MgAl₂O₄, or MgO, and a phosphor phase made of YAG containing Ce.

However, in the ceramic composite disclosed in JP-A-2012-062459, although a thermal conductivity is improved by mixing and sintering of a high thermal conductive filler, it is difficult to sufficiently improve fluorescence extraction efficiency.

### SUMMARY

In order to solve the above problems, one embodiment of a phosphor according to the present disclosure is formed of a phosphor body including a phosphor phase formed of A₃B₅O₁₂:Ce having a garnet structure, and a matrix phase having a refractive index higher than that of the phosphor phase. A content of the phosphor phase is 56 vol % or more and 70 vol % or less in a volume ratio with respect to the phosphor body. A ratio of Ce to A in terms of number of atoms is 0.004 or more and 0.04 or less. A thickness of the phosphor body is 45 μm or more and 150 μm or less. A is at least one selected from the group including Lu, Gd, Tb, Ga, and Y, and B is Al.

One aspect of a wavelength conversion device according to the present disclosure includes: a substrate; the phosphor according to the above aspect, provided on the substrate and configured to convert incident excitation light into fluorescence; and a reflective layer provided at an opposite side to a light incident side of the phosphor from and configured to reflect the excitation light and the fluorescence.

Another aspect of the wavelength conversion device according to present disclosure includes: a substrate; the phosphor according to the above aspect, provided on the substrate and configured to convert incident excitation light into fluorescence; and an optical layer provided on a light incident side of the phosphor, and configured to transmit the excitation light and reflect the fluorescence.

One aspect of an illumination device according to the present disclosure includes: a light source configured to emit excitation light; and the wavelength conversion device according to the above aspect on which the excitation light is incident.

One aspect of a projector according to the present disclosure includes: the illumination device according to the above aspect; a light modulation device configured to modulate light emitted from the illumination device; and a projection optical device configured to project the light modulated by the light modulation device.

### BRIEF DESCRIPTION OF THE DRAWINGS

FIG. 1 is a schematic configuration diagram showing a projector according to a first embodiment.

FIG. 2 is a schematic configuration diagram showing an illumination device according to the first embodiment.

FIG. 3 is a cross-sectional view showing a configuration of a wavelength conversion device.

FIG. 4 is an SEM image of a phosphor.

FIG. 5 is a diagram showing an emission spectrum of the phosphor.

FIG. 6 is a schematic configuration diagram showing an illumination device according to a second embodiment.

### DESCRIPTION OF EMBODIMENTS

Embodiments of the present disclosure will be described below in detail with reference to the drawings. In the drawings used in the description below, a characteristic portion is enlarged for convenience in some cases for clarity of the characteristic thereof, and the dimension ratio and other factors of each component are therefore not always equal to actual values.

### First Embodiment

Embodiments of the present disclosure will be described below.

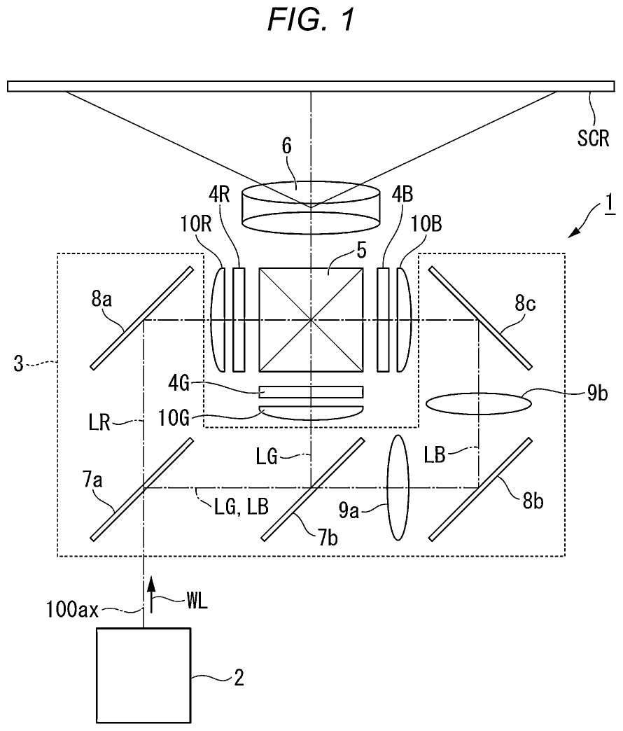

FIG. 1 is a schematic configuration diagram showing a projector according to a first embodiment.

As shown in FIG. 1, a projector 1 according to the embodiment is a projection-type image display device that displays an image on a screen SCR. The projector 1 includes an illumination device 2, a color separation optical system 3, a light modulation device 4R, a light modulation device 4G, a light modulation device 4B, a light combining system 5, and a projection optical device 6.

The illumination device 2 emits white illumination light WL toward the color separation optical system 3. A configuration of the illumination device 2 will be described in detail below.

The color separation optical system 3 separates the illumination light WL emitted from the illumination device 2 into red light LR, green light LG, and blue light LB. The color separation optical system 3 includes a first dichroic mirror 7a, a second dichroic mirror 7b, a first total reflection mirror 8a, a second total reflection mirror 8b, a third total reflection mirror 8c, a first relay lens 9a, and a second relay lens 9b.

The first dichroic mirror 7a separates the illumination light WL from the illumination device 2 into the red light LR and light including the green light LG and the blue light LB. The first dichroic mirror 7a transmits the red light LR and reflects the light containing the green light LG and the blue light LB. Meanwhile, the second dichroic mirror 7b reflects the green light LG and transmits the blue light LB. Accordingly, the second dichroic mirror 7b separates the light containing the green light LG and the blue light LB into the green light LG and the blue light LB.

The first total reflection mirror 8a is disposed in an optical path of the red light LR, and reflects the red light LR transmitted through the first dichroic mirror 7a toward the light modulation device 4R. Meanwhile, the second total reflection mirror 8b and the third total reflection mirror 8c are disposed in an optical path of the blue light LB, and guide the blue light LB transmitted through the second dichroic mirror 7b to the light modulation device 4B. The green light LG is reflected from the second dichroic mirror 7b toward the light modulation device 4G.

The first relay lens 9a is disposed between the second dichroic mirror 7b and the second total reflection mirror 8b in the optical path of the blue light LB. The second relay lens 9b is disposed between the second total reflection mirror 8b and the third total reflection mirror 8c in the optical path of the blue light LB. The first relay lens 9a and the second relay lens 9b compensate for optical loss of the blue light LB resulting from the fact that an optical path length of the blue light LB is longer than optical path lengths of the red light LR and the green light LG.

The light modulation device 4R modulates the red light LR in accordance with image information to form image light corresponding to the red light LR. The light modulation device 4G modulates the green light LG in accordance with image information to form image light corresponding to the green light LG. The light modulation device 4B modulates the blue light LB according to image information to form an image light corresponding to the blue light LB.

The light modulation devices 4R, 4G, and 4B are each, for example, a transmissive liquid crystal panel. Polarizing plates (not shown) are disposed at a light incident side and a light emission side of the liquid crystal panel.

A field lens 10R is disposed at the light incident side of the light modulation device 4R. The field lens 10R parallelizes the red light LR to be incident on the light modulation device 4R. A field lens 10G is disposed at the light incident side of the light modulation device 4G. The field lens 10G parallelizes the green light LG to be incident on the light modulation device 4G. A field lens 10B is disposed at the light incident side of the light modulation device 4B. The field lens 10B parallelizes the blue light LB to be incident on the light modulation device 4B.

The image light output from the light modulation device 4R, the image light output from the light modulation device 4G, and the image light output from the light modulation device 4B enter the light combining system 5. The light combining system 5 combines the image light corresponding to the red light LR, the image light corresponding to the green light LG, and the image light corresponding to the blue light LB with one another and emits the combined image light toward the projection optical device 6. For example, a cross dichroic prism is used for the light combining system 5.

The projection optical device 6 includes a plurality of projection lenses. The projection optical device 6 enlarges the combined image light from the light combining system 5 and projects the enlarged image light toward the screen SCR. Accordingly, an enlarged image is displayed on the screen SCR.

Hereinafter, a configuration of the illumination device 2 will be described.

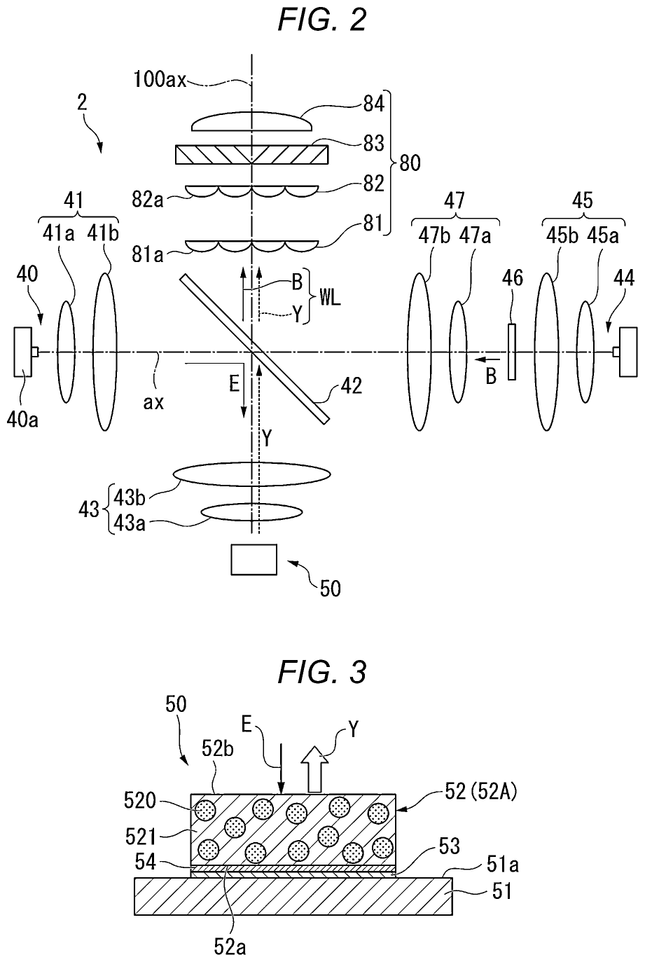

FIG. 2 is a schematic configuration diagram showing the illumination device 2 according to the embodiment.

As shown in FIG. 2, the illumination device 2 includes a first light source 40, a collimating system 41, a dichroic mirror 42, a first condensing system 43, a wavelength conversion device 50, a second light source 44, a second condensing system 45, a diffuser 46, and a collimating system 47.

The first light source 40 includes a plurality of semiconductor lasers 40a that emit blue excitation light E made of a laser beam. A peak of an emission intensity of the excitation light E is, for example, 445 nm. The plurality of semiconductor lasers 40a are arranged in an array manner in one plane orthogonal to an optical axis ax of the first light source 40. The semiconductor laser 40a may be a semiconductor laser that emits a blue light having a wavelength other than 445 nm, for example, 455 nm or 460 nm. The optical axis ax of the first light source 40 is orthogonal to an illumination optical axis 100ax of the illumination device 2.

The first light source 40 according to the embodiment corresponds to a “light source” in the claims.

The collimating system 41 includes a first lens 41a and a second lens 41b. The collimating system 41 substantially parallelizes the light output from the first light source 40. The first lens 41a and the second lens 41b are each formed of a convex lens.

The dichroic mirror 42 is disposed in an optical path from the collimating system 41 to the first condensing system 43 in a direction intersecting each of the optical axis ax of the first light source 40 and the illumination optical axis 100ax at an angle of 45°. The dichroic mirror 42 reflects a blue light component and transmits a red light component and a green light component. Therefore, the dichroic mirror 42 reflects the excitation light E and blue light B and transmits yellow fluorescence Y.

The first condensing system 43 condenses the excitation light E transmitted through the dichroic mirror 42 and causes the excitation light E to enter the wavelength conversion device 50, and substantially parallelizes the fluorescence Y emitted from the wavelength conversion device 50. The first condensing system 43 includes a first lens 43a and a second lens 43b. The first lens 43a and the second lens 43b are each formed of a convex lens.

The second light source 44 is formed of a semiconductor laser having a wavelength band same as a wavelength band of the first light source 40. The second light source 44 may be formed of one semiconductor laser or a plurality of semiconductor lasers. In addition, the second light source 44 may be formed of a semiconductor laser having a wavelength band different from that of the semiconductor laser of the first light source 40.

The second condensing system 45 includes a first lens 45a and a second lens 45b. The second condensing system 45 condenses the blue light B emitted from the second light source 44 on or near a diffusion surface of the diffuser 46. The first lens 45a and the second lens 45b are each formed of a convex lens.

The diffuser 46 diffuses the blue light B emitted from the second light source 44, and generates the blue light B having a light distribution close to a light distribution of the fluorescence Y emitted from the wavelength conversion device 50. As the diffuser 46, for example, a polished glass made of an optical glass can be used.

The collimating system 47 includes a first lens 47a and a second lens 47b. The collimating system 47 substantially parallelizes the light output from the diffuser 46. The first lens 47a and the second lens 47b are each formed of a convex lens.

The blue light B emitted from the second light source 44 is reflected by the dichroic mirror 42, and is combined with the fluorescence Y emitted from the wavelength conversion device 50 and transmitted through the dichroic mirror 42 to generate the white illumination light WL. The illumination light WL enters a uniform illumination optical system 80.

The uniform illumination optical system 80 includes a first lens array 81, a second lens array 82, a polarization conversion element 83, and a superimposing lens 84.

The first lens array 81 includes a plurality of first lenses 81a for dividing the illumination light WL from the illumination device 2 into a plurality of partial luminous fluxes. The plurality of first lenses 81a are arranged in a matrix in a plane perpendicular to the illumination optical axis 100ax.

The second lens array 82 includes a plurality of second lenses 82a corresponding to the plurality of first lenses 81a in the first lens array 81. The plurality of second lenses 82a are arranged in a matrix in a plane perpendicular to the illumination optical axis 100ax.

The second lens array 82, together with the superimposing lens 84, forms images of the respective first lenses 81a of the first lens array 81 in the vicinity of image formation regions of the light modulation device 4R, the light modulation device 4G, and the light modulation device 4B.

The polarization conversion element 83 converts the light emitted from the second lens array 82 into one kind of linearly polarized light. The polarization conversion element 83 includes, for example, polarization separation films and retardation films (not shown).

The superimposing lens 84 condenses the respective partial luminous fluxes emitted from the polarization conversion element 83 and superimposes the condensed light beams in the vicinity of the image formation regions of the light modulation device 4R, the light modulation device 4G, and the light modulation device 4B.

Next, a configuration of the wavelength conversion device 50 will be described.

FIG. 3 is a cross-sectional view showing the configuration of the wavelength conversion device 50. FIG. 3 corresponds to a cross section of the wavelength conversion device 50 taken along a plane including the illumination optical axis 100ax in FIG. 2.

As shown in FIG. 3, the wavelength conversion device 50 includes a substrate 51, a phosphor 52, a bonding layer 53, and a reflective layer 54. The wavelength conversion device 50 according to the embodiment is a fixed type wavelength conversion device in which an incident position of the excitation light E on the phosphor 52 does not change over time.

The substrate 51 supports the reflective layer 54 and the phosphor 52 through the bonding layer 53. The substrate 51 is formed of, for example, a metal material having a high thermal conductivity, such as aluminum or copper. The bonding layer 53 is formed of, for example, a bonding material having a high thermal conductivity, such as a nanosilver paste. The bonding layer 53 bonds a first surface 51a as a surface of the substrate 51, and the phosphor 52.

The phosphor 52 has a first surface 52a facing the substrate 51 and a second surface 52b at an opposite side from the first surface 52a. The phosphor 52 emits, from the second surface 52b, the fluorescence Y obtained by wavelength-converting the excitation light E incident from the second surface 52b. The phosphor 52 includes a phosphor body 52A including a phosphor phase 520 and a matrix phase 521.

The reflective layer 54 is provided to face the first surface 51a of the substrate 51 with the bonding layer 53 interposed therebetween. That is, the reflective layer 54 is provided between the substrate 51 and the first surface 52a of the phosphor 52. The reflective layer 54 is formed of a metal film such as silver having a high optical reflectance, a dielectric multilayer film, or a combination of these films. The reflective layer 54 reflects the fluorescence Y directed toward an opposite side of a light incident side of the phosphor 52 (the first surface 52a side) toward the light incident side (the second surface 52b side). The reflective layer 54 may reflect a part of the excitation light E to the light incident side (the second surface 52b side), and the excitation light E reflected by the reflective layer 54 is used to excite the fluorescence Y.

The wavelength conversion device 50 according to the embodiment functions as a reflective wavelength conversion device that emits the fluorescence Y from the second surface 52b of the phosphor 52 on which the excitation light E is incident.

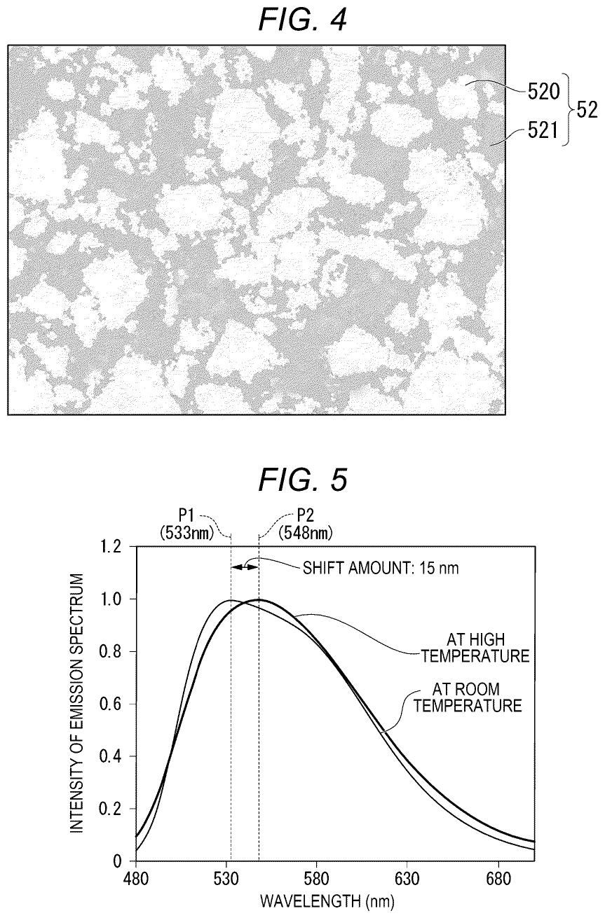

FIG. 4 shows a main part configuration of the phosphor 52 according to the embodiment. FIG. 4 is an image obtained by imaging of the phosphor 52 using a SEM (scanning electron microscope).

The phosphor phase 520 shown in FIG. 4 contains phosphor particles made of A₃B₅O₁₂:Ce having a garnet structure. In the phosphor phase 520 according to the embodiment, A is Y (yttrium) and B is AL (aluminum). That is, the phosphor phase 520 according to the embodiment contains phosphor particles made of yttrium aluminum garnet (YAG (Y₃Al₅O₁₂):Ce) to which cerium (Ce) is added as an activator.

The matrix phase 521 is a transparent ceramic that functions as a binder for binding a plurality of phosphor particles forming the phosphor phase 520 to each other and that allows fluorescence emitted by the phosphor phase 520 to pass through the matrix phase. The matrix phase 521 according to the embodiment is made of aluminum nitride (AlN). The matrix phase 521 has a refractive index (2.2) higher than a refractive index of YAG:Ce (1.8) forming the phosphor phase 520.

A thermal conductivity of AlN forming the matrix phase 521 is about 285 W/m·K, and a thermal conductivity of YAG:Ce forming the phosphor phase 520 is about 9 W/m·K. That is, the matrix phase 521 has a thermal conductivity sufficiently higher than the thermal conductivity of the phosphor phase 520.

The thermal conductivity of the matrix phase 521 according to the embodiment is sufficiently higher than the thermal conductivity of Al₂O₃ (alumina) (about 30 W/m·K), which is generally used as the matrix phase of a ceramic phosphor. Therefore, the phosphor 52 according to the embodiment has excellent thermal conductivity and excellent heat dissipation as compared with a phosphor in the related art that uses Al₂O₃ as the matrix phase.

In the phosphor 52 according to the embodiment, a thickness of the phosphor body 52A is set to be 45 μm or more and 150 μm or less. In general, the phosphor is used with an optical layer, such as an anti-reflection layer, formed on the surface. Therefore, when the thickness of the phosphor body 52A of the phosphor 52 is less than 45 μm, forming an optical layer on the surface of the phosphor body 52A may cause warping due to a deposition stress of the optical layer, which may result in breakage. Further, when the thickness is less than 45 μm, the thickness is too small and cracking or the like may occur during production.

In addition, when the thickness is more than 150 μm, an average transmittance of the fluorescence Y in the phosphor 52 decreases to less than 84%, so that extraction efficiency of the fluorescence Y decreases. When the average transmittance of the fluorescence Y is less than 84%, it means that the fluorescence Y emitted from the phosphor 52 is at a level that cannot be practically used as the illumination light for the projector.

In addition, when the thickness is more than 150 μm, the thickness is too large, so that the heat dissipation of the phosphor 52 may decrease, and fluorescence conversion efficiency may decrease.

In the embodiment, the thickness of the phosphor 52 is, for example, 45 μm.

In general, it is known that, when a temperature of the phosphor increases, an emission spectrum of fluorescence shifts to a long wavelength side and emission efficiency decreases. One of the reasons is that the emission spectrum shifts to the long wavelength side, and thus energy to be used when the excitation light is subjected to fluorescence conversion is increased. That is, in order to enhance the fluorescence conversion efficiency in the phosphor, it is effective to reduce the shift of the emission spectrum to the long wavelength side due to a temperature rise.

The present inventor focuses on enhancing the fluorescence conversion efficiency of the phosphor by reducing the shift of the emission spectrum to the long wavelength side due to the temperature rise. The present inventor then considers that it is possible to implement a phosphor in which a decrease in the fluorescence conversion efficiency due to the temperature rise is prevented by reducing, to 20 nm or less, a shift amount of the emission spectrum to the long wavelength side due to the temperature rise. The present inventor considers that when a content of Ce in the phosphor phase is too small, the excitation light is not favorably absorbed in the phosphor phase, and an amount of extracted fluorescence decreases.

In general, when the content of Ce in the phosphor phase is excessively large in the phosphor, the fluorescence generated in the phosphor phase is scattered inward due to a refractive index difference with the matrix phase and is re-absorbed by Ce, which may reduce a fluorescence extraction yield. In particular, in the phosphor 52 according to the embodiment, the heat dissipation is enhanced by using AlN as the matrix phase 521 as described above. AlN has a refractive index higher than a refractive index of alumina (1.63), which is generally used as the matrix phase. That is, in the phosphor 52 according to the embodiment, the refractive index difference between the phosphor phase 520 and the matrix phase 521 is large, and Ce re-absorption may occur.

The present inventor considers that even in the phosphor that uses the matrix phase made of AlN, which has a higher refractive index than that of the phosphor phase, it is possible to prevent a decrease in external quantum efficiency of fluorescence and increase the amount of extracted fluorescence by appropriately setting the content of Ce in the phosphor phase and the thickness of the phosphor. The external quantum efficiency of the fluorescence Y means a ratio of the number of photons of the fluorescence Y emitted by excitation with the excitation light E to the number of photons of the excitation light E. More specifically, this is a value obtained by dividing the amount of fluorescence Y emitted from the phosphor 52 by the amount of excitation light E emitted to the phosphor 52.

Specifically, the phosphor 52 according to the embodiment includes the phosphor body 52A including the phosphor phase 520 made of YAG (Y₃Al₅O₁₂):Ce having a garnet structure, and the matrix phase 521 having a refractive index higher than a refractive index of the phosphor phase 520. The content of the phosphor phase 520 is 56 vol % or more and 70 vol % or less in terms of volume ratio in the phosphor body 52A, and the content of Ce in the phosphor phase 520 is such that a ratio of Ce to Y in terms of number of atoms is 0.004 or more and 0.04 or less. Hereinafter, in the present specification, a volume ratio of the phosphor phase 520 to the phosphor body 52A is referred to as a “YAG amount”.

In the phosphor 52 according to the embodiment, when the YAG amount is 56 vol % or more and 70 vol % or less, a ratio of the matrix phase 521 is determined in a predetermined range (33 vol % or more and 44 vol % or less). In the phosphor 52 according to the embodiment, the matrix phase 521 is made of AlN having a high thermal conductivity. Therefore, the phosphor 52 according to the embodiment can prevent a decrease in fluorescence conversion efficiency due to a temperature rise by efficiently releasing heat accompanying fluorescence emission. That is, since the phosphor 52 according to the embodiment includes the matrix phase 521 having a high thermal conductivity, the temperature rise is prevented, and the shift of the emission spectrum of the fluorescence Y to the long wavelength side can be prevented.

More specifically, in the phosphor 52 according to the embodiment, the thermal conductivity of the phosphor body 52A can be 20 (W/m·K) or more. Therefore, by efficiently releasing the heat accompanying the fluorescence emission, it is possible to favorably prevent a decrease in fluorescence conversion efficiency due to a temperature rise.

That is, in the phosphor 52 according to the embodiment, by setting the YAG amount to 56 vol % or more and 70 vol % or less, it is possible to efficiently extract the fluorescence Y by taking a balance between improvement in the heat dissipation of the heat accompanying the fluorescence emission and prevention of the re-absorption of the fluorescence Y due to the refractive index difference.

FIG. 5 is a diagram showing an emission spectrum of the phosphor 52 according to the embodiment. A horizontal axis of FIG. 5 indicates a wavelength of the fluorescence Y emitted by the phosphor 52, and a vertical axis of FIG. 5 indicates an intensity of the emission spectrum. A solid line in FIG. 5 shows an emission spectrum of the phosphor 52 at room temperature (25° C.), and a broken line in FIG. 5 shows an emission spectrum of the phosphor 52 at a high temperature (250° C.). The temperature of 250° C. at a high temperature is a maximum temperature assumed for the phosphor 52 when used as the illumination device for the projector.

As shown in FIG. 5, in the phosphor 52 according to the embodiment, an emission peak wavelength P1 of the spectrum at room temperature is 533 nm, and an emission peak wavelength P2 of the spectrum at a high temperature is 548 nm. That is, in the case of the phosphor 52 according to the embodiment, a shift amount of the emission spectrum generated at a high temperature (250° C.) is 15 mm. That is, according to the phosphor 52 in the embodiment, the shift amount of the emission spectrum at a high temperature can be reduced to 20 nm or less.

As described above, in the phosphor 52 according to the embodiment, by setting the YAG amount to 56 vol % or more and 70 vol % or less, it is possible to reduce the shift amount of the emission spectrum due to a temperature rise to 20 nm or less by enhancing the heat dissipation. Accordingly, it is possible to generate the bright fluorescence Y by enhancing the fluorescence conversion efficiency by reducing the energy to be used during the fluorescence conversion due to the shift of the spectrum.

According to the phosphor 52 in the embodiment, by setting the content of Ce in the phosphor phase 520 to 0.004 or more and 0.04 or less, the excitation light E incident from the second surface 52b is more appropriately absorbed by the phosphor phase 520, thereby preventing backscattering of the excitation light E, thereby enhancing the fluorescence conversion efficiency, and increasing the amount of extracted fluorescence Y. Therefore, the external quantum efficiency of the fluorescence Y due to the excitation light E incident from the second surface 52b can be made 55% or more. The external quantum efficiency of 55% or more means that the fluorescence Y emitted from the phosphor 52 is practically used as illumination light for a projector without any problem.

In addition, since the phosphor 52 according to the embodiment includes the matrix phase 521 made of AlN having a high thermal conductivity, it is possible to prevent a decrease in fluorescence conversion efficiency due to a temperature rise by efficiently releasing heat accompanying fluorescence emission. Therefore, the phosphor 52 according to the embodiment can efficiently generate the bright fluorescence Y.

In the phosphor 52 according to the embodiment, the thickness of the phosphor body 52A is set to 45 μm or more and 150 μm or less, so that the average transmittance of the fluorescence Y can be set to 84% or more and 97% or less. Therefore, the phosphor 52 can efficiently extract the fluorescent light Y generated therein to the outside by transmitting the fluorescence Y.

The wavelength conversion device 50 according to the embodiment includes the substrate 51, the phosphor 52 that is provided on the substrate 51 and converts the incident excitation light E into the fluorescence, and the reflective layer 54 that is provided at the opposite side to the light incident side of the phosphor 52.

According to the wavelength conversion device 50 in the embodiment, it is possible to provide a reflective wavelength conversion device that efficiently extracts the bright fluorescence Y.

The illumination device 2 according to the embodiment includes the first light source 40 that emits the excitation light E and the wavelength conversion device 50 on which the excitation light E is incident.

According to the illumination device 2 in the embodiment, it is possible to provide an illumination device that has excellent wavelength conversion efficiency and emits the bright illumination light WL.

The projector 1 according to the embodiment includes the illumination device 2, the light modulation devices 4R, 4G, and 4B that modulate the light emitted from the illumination device 2, and the projection optical device 6 that projects the light modulated by the light modulation devices 4R, 4G, and 4B.

According to the projector 1 in the embodiment, it is possible to provide a projector having excellent display quality and high efficiency.

### Second Embodiment

Hereinafter, a projector according to a second embodiment will be described.

A basic configuration of the projector according to the second embodiment is the same as that of the first embodiment, and a configuration of the illumination device is different from that of the first embodiment. Therefore, the configuration of the illumination device will be described below.

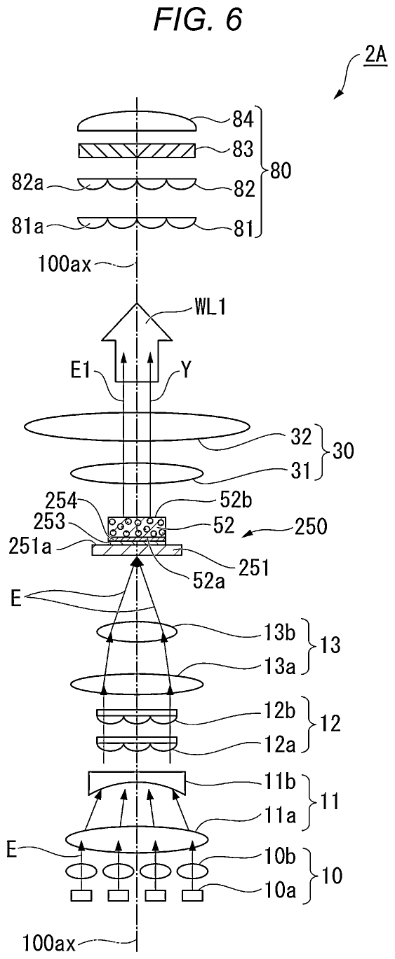

FIG. 6 is a schematic configuration diagram showing an illumination device 2A according to the second embodiment.

In FIG. 6, components common to those in the drawings used in the above embodiment are denoted by the same reference numerals, and a description thereof is omitted.

As shown in FIG. 6, the illumination device 2A includes an excitation light source unit 10, an afocal optical system 11, a homogenizer optical system 12, a condensing optical system 13, a wavelength conversion device 250, a pickup optical system 30, and a uniform illumination optical system 80.

The excitation light source unit 10 includes a plurality of semiconductor lasers 10a that emit the blue excitation light E as laser beams, and a plurality of collimator lenses 10b. The plurality of semiconductor lasers 10a are arranged in an array manner in a plane orthogonal to the illumination optical axis 100ax. The collimator lenses 10b are arranged in an array manner in the plane orthogonal to the illumination optical axis 100ax so as to correspond to the respective semiconductor lasers 10a. The collimator lens 10b converts the excitation light E emitted from the semiconductor laser 10a corresponding to the collimator lens 10b into parallel light.

The excitation light source unit 10 according to the embodiment corresponds to “light source” in the claims.

The afocal optical system 11 includes, for example, a convex lens 11a and a concave lens 11b. The afocal optical system 11 reduces a luminous flux diameter of the excitation light E including a parallel luminous flux emitted from the excitation light source unit 10.

The homogenizer optical system 12 includes, for example, a first multi-lens array 12a and a second multi-lens array 12b. The homogenizer optical system 12 makes a light intensity distribution of the excitation light uniform on the phosphor 52 of the wavelength conversion device 250, that is, a so-called top hat distribution. The homogenizer optical system 12, together with the condensing optical system 13, superimposes a plurality of small luminous fluxes emitted from a plurality of lenses of the first multi-lens array 12a and the second multi-lens array 12b on the phosphor 52 of the wavelength conversion device 250 from one another. Accordingly, the light intensity distribution of the excitation light E emitted to the phosphor 52 is made uniform.

The condensing optical system 13 includes, for example, a first lens 13a and a second lens 13b. In the embodiment, each of the first lens 13a and the second lens 13b is formed using a convex lens. The condensing optical system 13 is disposed in an optical path from the homogenizer optical system 12 to the wavelength conversion device 250, condenses the excitation light E, and causes the excitation light E thus condensed to enter the phosphor 52 of the wavelength conversion device 250.

The wavelength conversion device 250 according to the embodiment includes a substrate 251, the phosphor 52, a bonding layer 253, and an optical layer 254. The wavelength conversion device 250 according to the embodiment is a fixed-type wavelength conversion device in which an incident position of the excitation light E on the phosphor 52 does not change over time.

The substrate 251 supports the optical layer 254 and the phosphor 52 through the bonding layer 253. The substrate 251 is formed of, for example, a transparent material such as a glass or a plastic. The bonding layer 253 according to the embodiment is formed of, for example, a material having optical transparency, such as epoxy. The bonding layer 253 bonds a first surface 251a, which is a front surface of the substrate 251, and the phosphor 52.

In the phosphor 52 according to the embodiment, the excitation light E is incident from the first surface 52a facing the substrate 251, and the fluorescence Y is emitted from the second surface 52b. In the wavelength conversion device 250 according to the embodiment, the phosphor 52 transmits and emits not only the fluorescence Y but also a part of excitation light E1 whose wavelength is not converted. Accordingly, white illumination light WL1 is emitted from the phosphor 52.

The optical layer 254 is provided on the first surface 52a at the light incident side of the phosphor 52. The optical layer 254 includes a dichroic mirror that transmits the excitation light E and reflects the fluorescence Y.

The wavelength conversion device 250 according to the embodiment functions as a transmissive wavelength conversion device that emits the illumination light WL1 containing the fluorescence Y from the second surface 52b opposite to the first surface 52a of the phosphor 52 on which the excitation light E is incident.

The pickup optical system 30 includes, for example, a first collimating lens 31 and a second collimating lens 32. The pickup optical system 30 is a parallelizing optical system for substantially parallelizing the light emitted from the phosphor 52 of the wavelength conversion device 250. Each of the first collimating lens 31 and the second collimating lens 32 is formed using a convex lens. The light parallelized by the pickup optical system 30 is incident on the uniform illumination optical system 80.

### Effects of Second Embodiment

According to the embodiment, the transmissive wavelength conversion device 250 that generates the bright fluorescence Y may be implemented by using the phosphor 52 that can increase an amount of extracted fluorescence Y. In addition, in the illumination device 2A according to the embodiment, by providing the transmissive wavelength conversion device 250, it is also possible to obtain the effect same as that of the first embodiment in which the wavelength conversion efficiency is excellent and the bright illumination light WL1 can be emitted.

The technical scope of the present disclosure is not limited to the embodiments described above, and a variety of changes can be made thereto without departing from the intent of the present disclosure.

Specific descriptions of shapes, numbers, arrangements, materials, manufacturing methods, and the like of the respective component elements of the phosphor, the wavelength conversion device, the illumination device, and the projector described in the above embodiments are not limited to those of the above embodiments, and can be appropriately changed.

In the above embodiments, YAG containing Ce is taken as an example of the phosphor phase 520, and the present disclosure is also applicable to a case of using a phosphor phase containing Ce in at least one of Lu₃Al₅O₁₂, Tb₃Al₅O₁₂, Ga₃Al₅O₁₂, and Gd₃Al₅O₁₂. That is, in addition to the case of using Y (yttrium), the present disclosure is also applicable to a case in which A in the garnet structure (A₃B₅O₁₂:Ce) is replaced with any of Lu (lutetium), Gd (gallium), Tb (terbium), and Ga (gallium) providing emission characteristics similar to those of Y.

The present disclosure will be summarized below as additional remarks.

### Additional Remark 1

A phosphor includes:
a phosphor body including a phosphor phase made of A₃B₅O₁₂:Ce having a garnet structure, and a matrix phase having a refractive index higher than a refractive index of the phosphor phase, wherein
a content of the phosphor phase is 56 vol % or more and 70 vol % or less in terms of volume ratio with respect to the phosphor body,
a ratio of Ce to A in terms of number of atoms is 0.004 or more and 0.04 or less, and
a thickness of the phosphor body is 45 μm or more and 150 μm or less.

A is at least one selected from the group consisting of Lu, Gd, Tb, Ga, and Y, and B is Al.

According to the phosphor having such a configuration, re-absorption of fluorescence in the phosphor phase is prevented to enhance external quantum efficiency, and an amount of extracted fluorescence can be increased by balancing a thermal conductivity and the external quantum efficiency. By appropriately adjusting the thickness of the phosphor, an average transmittance of the fluorescence can be enhanced, thereby further enhancing the fluorescence extraction efficiency. Therefore, the phosphor having such a configuration may efficiently generate bright fluorescence.

### Additional Remark 2

In the phosphor according to additional remark 1, A is Y.

According to such a configuration, it is possible to implement a phosphor that efficiently generates bright fluorescence including a phosphor phase made of YAG (Y₃Al₅O₁₂):Ce.

### Additional Remark 3

In the phosphor according to additional remark 1 or additional remark 2, the matrix phase is AlN.

According to such a configuration, since the phosphor includes a matrix phase made of AlN having a high thermal conductivity, it is possible to prevent a decrease in fluorescence conversion efficiency due to a temperature rise by efficiently releasing heat accompanying fluorescence emission.

### Additional Remark 4

In the phosphor according to any one of additional remarks 1 to 3,
an average transmittance of light having a wavelength band of 500 nm or more and 800 nm or less is 84% or more and 97% or less.

According to such a configuration, it is possible to implement a configuration that efficiently extracts fluorescence having a wavelength band of 500 nm or more and 800 nm or less.

### Additional Remark 5

A wavelength conversion device includes: a substrate;
the phosphor according to any one of additional remarks 1 to 4 provided on the substrate and configured to convert incident excitation light into fluorescence; and
a reflective layer provided at an opposite side of a light incident side of the phosphor.

According to the wavelength conversion device having such a configuration, it is possible to provide a reflective wavelength conversion device that efficiently extracts bright fluorescence.

### Additional Remark 6

A wavelength conversion device includes: a substrate;
the phosphor according to any one of additional remarks 1 to 4 provided on the substrate and configured to convert incident excitation light into fluorescence; and
an optical layer provided on a light incident side of the phosphor and configured to transmit the excitation light and reflect the fluorescence.

According to the wavelength conversion device having such a configuration, it is possible to provide a transmissive wavelength conversion device that efficiently extracts bright fluorescence.

### Additional Remark 7

An illumination device includes:
a light source configured to emit the excitation light; and
the wavelength conversion device according to additional remark 5 or 6, on which the excitation light is incident.

According to the illumination device having such a configuration, it is possible to provide an illumination device that has excellent wavelength conversion efficiency and emits a bright illumination light.

### Additional Remark 8

A projector includes:
the illumination device according to additional remark 7;
a light modulation device configured to modulate light emitted from the illumination device; and
a projection optical device configured to project the light modulated by the light modulation device.

According to the projector having such a configuration, it is possible to provide a projector having excellent display quality and high efficiency.

### EXAMPLES

Hereinafter, the present disclosure will be described in more detail with reference to Examples, and the present disclosure is not limited to Examples.

### First Evaluation

In general, the higher the number of Ce atoms with respect to the number of Y atoms in YAG (Y₃Al₅O₁₂):Ce (hereinafter, referred to as a Ce/Y ratio), the higher the external quantum efficiency. First, the Ce/Y ratio was fixed at a low value of 0.004, and samples having different contents of the phosphor phase were prepared as the following Examples 1 to 3 and Comparative Examples 1 and 2, and the respective samples were evaluated.

### Example 1

First, an AlN powder that constitutes the matrix phase was kneaded with YAG powder with a Ce/Y ratio of 0.004 and a content of the phosphor phase of 56 vol % in terms of volume ratio of the entire phase including the matrix phase and the phosphor phase, and the kneaded product was subjected to uniaxial molding to have a diameter of 20 mm and fired at 1800° C. in a nitrogen atmosphere. Thereafter, polishing was performed to produce a phosphor in Example 1 having a thickness of 45 μm.

### Example 2

A phosphor in Example 2 was produced by carrying out the steps same as in Example 1 except that a powder in which the content of the phosphor phase was 60 vol % was used as the YAG powder.

### Example 3

A phosphor in Example 3 was produced by carrying out the steps same as in Example 1 except that a powder in which the content of the phosphor phase was 70 vol % was used as the YAG powder.

### Comparative Example 1

A phosphor in Comparative Example 1 was produced by carrying out the steps same as in Example 1 except that a powder in which the content of the phosphor phase was 50 vol % was used as the YAG powder.

### Comparative Example 2

A phosphor in Comparative Example 2 was produced by carrying out the steps same as in Example 1 except that a powder in which the content of the phosphor phase was 80 vol % was used as the YAG powder.

### Evaluation of Examples 1 to 3 and Comparative Examples 1 and 2

In each of Examples 1 to 3 and Comparative Examples 1 and 2 described above, the external quantum efficiency (unit: %) and the thermal conductivity (unit: W/m·K) were checked as described below, and a phosphor having high external quantum efficiency and thermal conductivity were determined to be a phosphor having high light utilization efficiency and excellent heat dissipation. Determination results are shown in Table 1.

In Table 1, samples with the external quantum efficiency at 55% or more were evaluated as A (acceptable), and samples with the external quantum efficiency at less than 55% were evaluated as B (unacceptable). In addition, in Table 1, samples with a thermal conductivity of 20% or more were evaluated as A (acceptable), and samples with a thermal conductivity of less than 20% were evaluated as B (unacceptable).

Further, as an overall evaluation, samples whose evaluation items of the external quantum efficiency and the thermal conductivity were both A were rated A (acceptable), and samples whose evaluation items of either the external quantum efficiency or the thermal conductivity was B were rated B (unacceptable).

TABLE 1

| | | | External | | | | |
|---|---|---|---|---|---|---|---|
| | | YAG | quantum | Thermal | Evaluation | Evaluation | |
| | Ce/Y | amount | efficiency | conductivity | of quantum | of thermal | |
| | ratio | (%) | (%) | (W/m · K) | efficiency | conductivity | Determination |
| Comparative | 0.004 | 50 | 53 | 41.4 | B | A | B |
| Example 1 | | | | | | | |
| Example 1 | 0.004 | 56 | 59 | 40.6 | A | A | A |
| Example 2 | 0.004 | 60 | 62 | 31.4 | A | A | A |
| Example 3 | 0.004 | 70 | 61 | 22.1 | A | A | A |
| Comparative | 0.004 | 80 | 62 | 14 | A | B | B |
| Example 2 | | | | | | | |

A . . . 55 or more
A . . . 20 or more
B . . . less than 55
B . . . less than 20

As shown in Table 1, in the case of Comparative Example 1 (YAG amount: 50%), although a sufficient value of the thermal conductivity of 41.4 can be obtained by increasing a ratio of the matrix phase, the excitation light is not absorbed by the phosphor phase due to a decrease in the ratio of the phosphor phase, and the external quantum efficiency decreases to 53%. In the case of Comparative Example 2 (YAG amount: 80%), the external quantum efficiency is 62%, which is a sufficient value, but the thermal conductivity is 14, which is not sufficient.

Based on the above results, according to the phosphors in Examples 1 to 3, it is confirmed that it is possible to generate bright fluorescence by enhancing the fluorescence extraction efficiency by enhancing the thermal conductivity and the quantum efficiency in a balanced manner by setting the YAG amount to 56% or more and 70% or less.

### Second Evaluation

Next, an appropriate range for the Ce/Y ratio was evaluated. In Table 1, the content of the phosphor phase having the lowest external quantum efficiency of fluorescence within the range of the YAG amount was fixed at 56 vol %, and samples with different Ce/Y ratios were prepared as the following Examples 4 to 11 and Comparative Examples 3 and 4, and the respective samples were evaluated.

### Example 4

A phosphor in Example 4 was produced by carrying out the steps same as in Example 1 except that a powder in which the Ce/Y ratio was 0.007 was used as the YAG powder.

### Example 5

A phosphor in Example 5 was produced by carrying out the steps same as in Example 1 except that a powder in which the Ce/Y ratio was 0.01 was used as the YAG powder.

### Example 6

A phosphor in Example 6 was produced by carrying out the steps same as in Example 1 except that a powder in which the Ce/Y ratio was 0.013 was used as the YAG powder.

### Example 7

A phosphor in Example 7 was produced by carrying out the steps same as in Example 1 except that a powder in which the Ce/Y ratio was 0.015 was used as the YAG powder.

### Example 8

A phosphor in Example 8 was produced by carrying out the steps same as in Example 1 except that a powder in which the Ce/Y ratio was 0.02 was used as the YAG powder.

### Example 9

A phosphor in Example 9 was produced by carrying out the steps same as in Example 1 except that a powder in which the Ce/Y ratio was 0.025 was used as the YAG powder.

### Example 10

A phosphor in Example 10 was produced by carrying out the steps same as in Example 1 except that a powder in which the Ce/Y ratio was 0.03 was used as the YAG powder.

### Example 11

A phosphor in Example 11 was produced by carrying out the steps same as in Example 1 except that a powder in which the Ce/Y ratio was 0.04 was used as the YAG powder.

### Comparative Example 3

A phosphor in Comparative Example 3 was produced by carrying out the steps same as in Example 1 except that a powder in which the Ce/Y ratio was 0.002 was used as the YAG powder.

### Comparative Example 4

A phosphor in Comparative Example 4 was produced by carrying out the steps same as in Example 1 except that a powder in which the Ce/Y ratio was 0.05 was used as the YAG powder.

### Evaluation of Examples 4 to 11 and Comparative Examples 3 and 4

In each of Examples 4 to 11 and Comparative Examples 3 and 4 described above, the external quantum efficiency (unit: %) was checked, and a phosphor having high external quantum efficiency was determined to be a phosphor having high light utilization efficiency. Determination results are shown in Table 2.

In Table 2, samples with external quantum efficiency at 55% or more were evaluated as A (acceptable), and samples with external quantum efficiency at less than 55% were evaluated as B (unacceptable).

TABLE 2

| | Ce/Y | YAG amount | External quantum | |
|---|---|---|---|---|
| | ratio | (%) | efficiency (%) | Determination |
| Comparative | 0.002 | 56 | 54 | B |
| Example 3 | | | | |
| Example 1 | 0.004 | 56 | 59 | A |
| Example 4 | 0.007 | 56 | 65 | A |
| Example 5 | 0.01 | 56 | 68 | A |
| Example 6 | 0.013 | 56 | 73 | A |
| Example 7 | 0.015 | 56 | 74 | A |
| Example 8 | 0.02 | 56 | 77 | A |
| Example 9 | 0.025 | 56 | 77 | A |
| Example 10 | 0.03 | 56 | 75 | A |
| Example 11 | 0.04 | 56 | 63 | A |
| Comparative | 0.05 | 56 | 40 | B |
| Example 4 | | | | |

A . . . 55 or more
B . . . less than 55

As shown in Table 2, in the case of Comparative Example 3 (Ce/Y ratio: 0.002), the Ce/Y ratio was too low, so that the excitation light is not absorbed by the phosphor phase, the ratio of backscattered light increases, and the external quantum efficiency of fluorescence decreases to 54%. That is, it is confirmed that the Ce/Y ratio is required to be 0.0004 or more as in the phosphor in Example 1.

It is confirmed that, according to the phosphors of Examples 4 to 10, the external quantum efficiency of fluorescence increases with an increase in the Ce/Y ratio. Further, it is also confirmed that the external quantum efficiency is highest when the Ce/Y ratio is around 0.02 and 0.025 (Examples 8 and 9), that the external quantum efficiency begins to decrease when the Ce/Y ratio is 0.03 (Example 10) and when the Ce/Y ratio was 0.04 (Example 11), and that the external quantum efficiency significantly decreases to 40% when the Ce/Y ratio is 0.05 (Comparative Example 4).

This is because the amount of Ce contained in the phosphor phase of the phosphor is excessively increased, thereby increasing re-absorption of fluorescence by Ce. That is, it is confirmed that, by setting the Ce/Y ratio to 0.004 or less as in the phosphor in Example 11, the re-absorption of fluorescence is prevented, and sufficient external quantum efficiency can be achieved.

### Third Evaluation

The external quantum efficiency of a phosphor changes depending on a thickness thereof. This is because a transmittance of light having a wavelength band of 500 nm to 800 nm changes depending on the thickness. In contrast, the content of the phosphor phase having the lowest external quantum efficiency was fixed at 56 vol %, and samples were prepared by varying the Ce/Y ratio and the thickness of the phosphor body as the following Examples 12 to 25 and Comparative Examples 5 to 9, and the respective samples were evaluated.

### Example 12

A phosphor in Example 12 was produced by carrying out the steps same as in Example 1 except that the thickness of the phosphor body was set to 100 μm.

### Example 13

A phosphor in Example 13 was produced by carrying out the steps same as in Example 1 except that the thickness of the phosphor body was set to 150 μm.

### Comparative Example 5

A phosphor in Comparative Example 5 was produced by carrying out the steps same as in Example 1, except that the thickness of the phosphor body was set to 200 μm.

### Example 14

A phosphor in Example 14 was produced by carrying out the steps same as in Example 1 except that a powder in which the Ce/Y ratio was 0.01 was used as the YAG powder.

### Example 15

A phosphor in Example 15 was produced by carrying out the steps same as in Example 1 except that a powder in which the Ce/Y ratio was 0.01 was used as the YAG powder and the thickness of the phosphor body was 100 μm.

### Example 16

A phosphor in Example 16 was produced by carrying out the steps same as in Example 1 except that a powder in which the Ce/Y ratio was 0.01 was used as the YAG powder and the thickness of the phosphor body was 150 μm.

### Comparative Example 6

A phosphor in Comparative Example 6 was produced by carrying out the steps same as in Example 1 except that a powder in which the Ce/Y ratio was 0.01 was used as the YAG powder and the thickness of the phosphor body was 200 μm.

### Example 17

A phosphor in Example 17 was produced by carrying out the steps same as in Example 1 except that a powder in which the Ce/Y ratio was 0.015 was used as the YAG powder.

### Example 18

A phosphor in Example 18 was produced by carrying out the steps same as in Example 1 except that a powder in which the Ce/Y ratio was 0.015 was used as the YAG powder and the thickness of the phosphor body was 100 μm.

### Example 19

A phosphor in Example 19 was produced by carrying out the steps same as in Example 1 except that a powder in which the Ce/Y ratio was 0.015 was used as the YAG powder and the thickness of the phosphor body was 150 μm.

### Comparative Example 7

A phosphor in Comparative Example 7 was produced by carrying out the steps same as in Example 1 except that a powder in which the Ce/Y ratio was 0.015 was used as the YAG powder and the thickness of the phosphor body was 200 μm.

### Example 20

A phosphor in Example 20 was produced by carrying out the steps same as in Example 1 except that a powder in which the Ce/Y ratio was 0.025 was used as the YAG powder.

### Example 21

A phosphor in Example 21 was produced by carrying out the steps same as in Example 1 except that a powder in which the Ce/Y ratio was 0.025 was used as the YAG powder and the thickness of the phosphor body was 100 μm.

### Example 22

A phosphor in Example 22 was produced by carrying out the steps same as in Example 1 except that a powder in which the Ce/Y ratio was 0.025 was used as the YAG powder and the thickness of the phosphor body was 150 μm.

### Comparative Example 8

A phosphor in Comparative Example 8 was produced by carrying out the steps same as in Example 1 except that a powder in which the Ce/Y ratio was 0.025 was used as the YAG powder and the thickness of the phosphor body was 200 μm.

### Example 23

A phosphor in Example 23 was produced by carrying out the steps same as in Example 1 except that a powder in which the Ce/Y ratio was 0.04 was used as the YAG powder.

### Example 24

A phosphor in Example 24 was produced by carrying out the steps same as in Example 1 except that a powder in which the Ce/Y ratio was 0.04 was used as the YAG powder and the thickness of the phosphor body was 100 μm.

### Example 25

A phosphor in Example 25 was produced by carrying out the steps same as in Example 1 except that a powder in which the Ce/Y ratio was 0.04 was used as the YAG powder and the thickness of the phosphor body was 150 μm.

### Comparative Example 9

A phosphor in Comparative Example 9 was produced by carrying out the steps same as in Example 1 except that a powder in which the Ce/Y ratio was 0.04 was used as the YAG powder and the thickness of the phosphor body was 200 μm.

### Evaluation of Examples 12 to 25 and Comparative Examples 5 to 9

In each of Examples 12 to 25 and Comparative Examples 5 to 9 described above, the external quantum efficiency (unit: %) and the average transmittance (unit: %) were checked, and a phosphor having high external quantum efficiency and high average transmittance was determined to be a phosphor having high light utilization efficiency. Determination results are shown in Table 3.

In addition, in Table 3, samples with external quantum efficiency at 55% or more were evaluated as A (acceptable), and samples with external quantum efficiency at less than 55% were evaluated as B (unacceptable). In addition, in Table 3, samples with an average transmittance of 84% or more were evaluated as A (acceptable), and samples with an average transmittance of less than 84% were evaluated as B (unacceptable).

Further, as an overall evaluation, samples whose evaluation items of the external quantum efficiency and the average transmittance were both A were rated A (acceptable), and samples whose evaluation items of either the external quantum efficiency or the average transmittance was B were rated B (unacceptable).

TABLE 3

| | | | | | Average | | | |
|---|---|---|---|---|---|---|---|---|
| | | | Thickness | External | transmittance | | | |
| | | YAG | of | quantum | of | Evaluation | | |
| | Ce/Y | amount | phosphor | efficiency | fluorescence | of quantum | Evaluation of | |
| | ratio | (%) | (μm) | (%) | (%) | efficiency | transmittance | Determination |
| Example 1 | 0.004 | 56 | 45 | 59 | 97 | A | A | A |
| Example 12 | 0.004 | 56 | 100 | 57 | 90 | A | A | A |
| Example 13 | 0.004 | 56 | 150 | 55 | 85 | A | A | A |
| Comparative | 0.004 | 56 | 200 | 48 | 80 | B | B | B |
| Example 5 | | | | | | | | |
| Example 14 | 0.01 | 56 | 45 | 70 | 94 | A | A | A |
| Example 15 | 0.01 | 56 | 100 | 66 | 89 | A | A | A |
| Example 16 | 0.01 | 56 | 150 | 63 | 84 | A | A | A |
| Comparative | 0.01 | 56 | 200 | 59 | 79 | A | B | B |
| Example 6 | | | | | | | | |
| Example 17 | 0.015 | 56 | 45 | 74 | 96 | A | A | A |
| Example 18 | 0.015 | 56 | 100 | 70 | 90 | A | A | A |
| Example 19 | 0.015 | 56 | 150 | 67 | 85 | A | A | A |
| Comparative | 0.015 | 56 | 200 | 63 | 80 | A | B | B |
| Example 7 | | | | | | | | |
| Example 20 | 0.025 | 56 | 45 | 77 | 95 | A | A | A |
| Example 21 | 0.025 | 56 | 100 | 72 | 89 | A | A | A |
| Example 22 | 0.025 | 56 | 150 | 68 | 84 | A | A | A |
| Comparative | 0.025 | 56 | 200 | 66 | 79 | A | B | B |
| Example 8 | | | | | | | | |
| Example 23 | 0.04 | 56 | 45 | 63 | 94 | A | A | A |
| Example 24 | 0.04 | 56 | 100 | 59 | 89 | A | A | A |
| Example 25 | 0.04 | 56 | 150 | 55 | 84 | A | A | A |
| Comparative | 0.04 | 56 | 200 | 51 | 79 | B | B | B |
| Example 9 | | | | | | | | |

A . . . 55 or more
A . . . 84 or more
B . . . less than 55
B . . . less than 84

As shown in Table 3, it is confirmed that, when phosphors having the same Ce/Y ratio are compared, the smaller the thickness of the phosphor, the higher the external quantum efficiency and the average transmittance. On the other hand, in each of Comparative Examples 5 to 9 (thickness: 200 μm), it is confirmed that at least one of the external quantum efficiency and the average transmittance is an insufficient value. That is, it is confirmed from Table 3 that if the thickness of the phosphor is 45 μm or more and 150 μm or less, the external quantum efficiency and average transmittance can be enhanced in a balanced manner, thereby enhancing the fluorescence extraction efficiency.

Based on the above results, according to the phosphors in Examples 1 to 25, it is confirmed that, by setting the YAG amount to 56% or more and 70% or less, the Ce/Y ratio to 0.004 or more and 0.04 or less, and the thickness of the phosphor body to 45 μm or more and 150 μm or less, the external quantum efficiency and the average transmittance are enhanced in a balanced manner, thereby enhancing the fluorescence extraction efficiency and generating bright fluorescence.

What is claimed is:

1. A phosphor comprising:
a phosphor body including a phosphor phase made of A₃B₅O₁₂:Ce having a garnet structure, and a matrix phase having a refractive index higher than a refractive index of the phosphor phase, wherein
a content of the phosphor phase is 56 vol % or more and 70 vol % or less in terms of volume ratio with respect to the phosphor body,
a ratio of Ce to A in terms of number of atoms is 0.004 or more and 0.04 or less,
a thickness of the phosphor body is 45 μm or more and 150 μm or less, and
A is at least one selected from a group consisting of Lu, Gd, Tb, Ga, and Y, and B is Al.

2. The phosphor according to claim 1, wherein
A is Y.

3. The phosphor according to claim 1, wherein
the matrix phase is AlN.

4. The phosphor according to claim 1, wherein
an average transmittance of light having a wavelength band of 500 nm or more and 800 nm or less is 84% or more and 97% or less.

5. A wavelength conversion device comprising:
a substrate;
the phosphor according to claim 1 provided on the substrate and configured to convert incident excitation light into fluorescence; and
a reflective layer provided at an opposite side to a light incident side of the phosphor.

6. A wavelength conversion device comprising:
a substrate;
the phosphor according to claim 1 provided on the substrate and configured to convert incident excitation light into fluorescence; and
an optical layer provided on a light incident side of the phosphor and configured to transmit the excitation light and reflect the fluorescence.

7. An illumination device comprising:
a light source configured to emit excitation light; and
the wavelength conversion device according to claim 5, on which the excitation light is incident.

8. A projector comprising:
the illumination device according to claim 7;
a light modulation device configured to modulate light emitted from the illumination device; and
a projection optical device configured to project the light modulated by the light modulation device.
